(19) United States
(12) Patent Application Publication
(10) Pub. No.: US 2025/0343407 A1
(43) Pub. Date: Nov. 6, 2025

(54) CIRCUIT AND METHOD FOR LIMITING OVERVOLTAGE, PARTICULARLY FOR A DC-DC CONVERTER

(71) Applicant: STMicroelectronics International N.V., Geneva (CH)

(72) Inventor: Bruno LECONTE, Rousset (FR)

(21) Appl. No.: 19/185,866

(22) Filed: Apr. 22, 2025

(30) Foreign Application Priority Data
May 2, 2024 (FR) 2404589

(51) Int. Cl. H02H 9/04; G06F 1/26; H02M 1/32; H02M 3/158

(52) U.S. Cl. CPC H02H 9/04; G06F 1/263; H02M 1/32; H02M 3/158

(57) ABSTRACT

A voltage limiting circuit is provided. An example voltage limiting circuit comprises a first terminal capable of receiving a first supply voltage from a first initial voltage by means of a first path at least inductive, a second terminal capable of receiving a second supply voltage from a second initial voltage by means of a second path at least inductive, the voltage difference between the two terminals being likely to have an overvoltage, a first MOS transistor having a drain and a source respectively connected to two terminals and control means, triggerable by the overvoltage itself and configured to automatically switch the first MOS transistor to a conducting state when the overvoltage reaches a first value and to limit the overvoltage to a second value higher than the first value.

### CROSS REFERENCE TO RELATED APPLICATION(S)

This application claims the priority benefit of French patent application number 2404589, filed on May 2, 2024, entitled “CIRCUIT ET PROCEDE DE LIMITATION DE SURTENSION, EN PARTICULIER POUR UNE ALIMENTATION A DECOUPAGE”, which is hereby incorporated by reference to the maximum extent allowable by law.

### TECHNICAL FIELD

The present disclosure relates to integrated circuits, particularly those incorporating a switched-mode power supply and disposed in a package, and more particularly, the limitation of an overvoltage during the operation of the switched-mode power supply.

### BACKGROUND

A switched-mode power supply device, for example of the buck converter type is well known to the person skilled in the art.

One example of embodiment of such a switched-mode power supply device of the prior art is schematically illustrated in FIG. 1.

This switched-mode power supply device ALMD includes a pair of MOS transistors T10, T20, switchable on command from a conventional control means PWMCTR, for example of the Pulse Width Modulation (PWM) type.

The transistor T10 may be a PMOS transistor whereas the transistor T20 may be an NMOS transistor.

Alternatively, the two transistors T10 and T20 may be two NMOS transistors.

The switched-mode power supply device ALMD includes a first power supply input PD1 and a second power supply input PD2.

When the pair of transistors T10 T20 is integrated within an integrated circuit IC, a first pad PD1 of the integrated circuit forms the first power supply input, and a second pad PD2 forms the second power supply input.

A third pad PD3 is connected to the common node ND of the two transistors T10 and T20.

The integrated circuit IC is typically incorporated into a package BT.

In addition, the various pads of the integrated circuit are conventionally connected to the pins of the package by bonding means, including for example wire bonding and a metal structure that makes it possible to carry the signals between the integrated circuit and the exterior, this metal structure being known to the person skilled in the art as “lead frame”.

These bonding means between the pads of the integrated circuit and the pins of the package are resistive but also inductive.

Thus, in the example of FIG. 1, the bonding means between the first pad PD1 and the first pin PIN1 of the package is illustrated by a parasitic inductive element LB1.

The bonding means between the second pad PD2 and the second pin PIN2 of the package BT is produced by a parasitic inductive element LB2.

The bonding means between the third pad PD3 and the third pin PIN3 of the package BT is produced by a parasitic inductive element LB3.

The first pin PIN1 of the package is intended to receive a first so-called “initial” voltage V1i, for example a supply voltage Vdd having a nominal value of 3 volts.

A first voltage V1, from this first initial voltage V1i is present on the first pad PD1.

The second pin PIN2 of the package BT is intended to receive a second so-called “initial” voltage V2i, for example the ground GND.

A second voltage V2, from of this second initial voltage V2i is present on the second pad PD2.

The switched-mode power supply device ALMD also includes an inductive element external to the package BT, referenced LOUT.

A first terminal of this external inductive element LOUT is connected to the third pin PIN3 and the other terminal of this external inductive element forms a power supply output BS of the switched-mode power supply device ALMD, intended to deliver an output voltage Vc, for example in the order of 1 volt.

The switched-mode power supply device ALMD also includes an output capacitor COUT connected between the power supply output BS and the second pin PIN2 of the package BT, in this case the ground.

The operation of such a device ALMD is conventional and well known to the person skilled in the art.

The first initial voltage V1i is for example equal to 3 volts and the device ALMD delivers an output voltage Vc in the order of 1 volt.

In this respect, the transistors T10 and T20 are successively conducting and non-conducting depending on the command delivered by the control means of PWMCTR.

The packages may be of different types (BGA, QFP, etc.). Among these packages, some may have relatively large dimensions. The wire bonding and the metal structures that carry the signals and the power supplies between the pads of the chip and the pins of the package may have a length of 2 to 20 mm.

They then have a stray inductance that may be between 2 and 20 nH.

When in operation, the transistor T10 switches from the “ON” state to the “OFF” state, the power supply current has a very fast transition to reach the zero value, the duration of this transition being very short, typically in the order of the nanosecond. During this very short period, an overvoltage occurs at the terminals of the bonding means having a stray inductance.

The external supply voltage between the pins PINi of the package is conventionally decoupled by external decoupling capacitors (not shown in FIG. 1).

However, the internal supply voltage between the pads PDi of the integrated circuit experience an overvoltage that stresses the transistor T10.

These voltage peaks caused by the stray inductances of the package impact the reliability of the switched-mode power supply device.

Indeed, the MOS transistors, designed to operate typically under 3 volts, will transiently experience very high voltages causing an accelerated degradation.

The degradation increases the resistance in the conducting state of the MOS transistor which impacts the efficiency of the switched-mode power supply.

Furthermore, in some cases, these voltage peaks may cause breakages in the gate oxides leading to permanent faults in the integrated circuit.

Finally, in this prior art, a decoupling capacitor is present between the pads PD1 and PD2. This coupling capacitor is not shown in FIG. 1 for reasons of simplicity and of clarity of the figure.

When the transistor T10 is in an OFF state, this decoupling capacitor forms with the parasitic inductive element LB1, a resonant circuit having a high quality factor because the energy is removed by the low resistance of this parasitic element LB1. The oscillations of this circuit are then responsible for an electromagnetic emission consequently creating electromagnetic interferences (usually designated by the person skilled in the art under the acronym “EMI”).

Therefore, there is a need to propose an alternative solution to the problem of the reliability of switched-mode power supply devices resulting from the aforementioned overvoltages.

### BRIEF SUMMARY

According to one embodiment, instead of using a solution based on decoupling capacitors resulting in an increase in the space requirement on silicon, it is proposed to replace these decoupling capacitors with an active voltage limiting circuit automatically activated in the event of excessive overvoltage on the supply voltage.

According to one embodiment, it is also proposed such a voltage limiting circuit having a much smaller space requirement on silicon compared to the solutions of the prior art using decoupling capacitors.

According to yet another embodiment, such a voltage limiting circuit is proposed that makes it possible to reduce the electromagnetic interferences.

The voltage limiting circuit proposed may be used particularly for switched-mode power supply devices, in particular but not limitatively those of the buck converter type, but also for any device for which an overvoltage from an initial supply voltage occurs through an inductive path.

According to one aspect, a voltage limiting circuit is thus proposed comprising a first terminal capable of receiving a first supply voltage from a first initial voltage, for example a supply voltage having a nominal value equal to 3 volts, by means of a first path at least inductive, for example but not necessarily by means of inductive bonding means present within an integrated circuit package.

This voltage limiting circuit also includes a second terminal capable of receiving a second supply voltage from a second initial voltage, for example the ground, by means of a second path at least inductive, for example once again an inductive bonding means of an integrated circuit package.

The voltage difference between the two terminals is likely to have an overvoltage.

The voltage limiting circuit also includes a first MOS transistor, preferably a PMOS transistor although this first transistor may also be an MOS transistor.

This first MOS transistor has a drain and a source respectively connected to two terminals of the voltage limiting circuit.

The voltage limiting circuit also includes control means triggerable by the overvoltage itself and configured to automatically switch the first MOS transistor to a conducting state when the overvoltage reaches a first value and to limit the overvoltage to a second value higher than the first value.

The use of an MOS transistor to limit the overvoltage is particularly advantageous in terms of surface on the silicon.

Moreover, this first transistor switches to a conducting state as soon as the value of the overvoltage reaches a threshold resulting in a gate/source voltage of this first transistor, higher than the threshold voltage of the transistor. The value of the current passing through this transistor is then low. In addition, when the overvoltage increases, the transistor becomes increasingly conducting with a current increasing until a percentage of the charge current is absorbed and then limiting the overvoltage to a second value. Indeed, there is an interaction between the resistor of the transistor in the conducting state and the overvoltage.

In addition, the overvoltage itself will trigger the switching of the transistor to the conducting state.

Therefore, there is no need to provide separate control means to trigger the voltage limiting circuit.

According to one embodiment, the control means include
a first resistor connected between the gate of the first transistor and the second terminal,
a capacitive divider connected between the first transistor and the first terminal, and
the resistor of the first transistor in its conducting state.

The capacitive divider includes for example a coupling capacitor connected between the first terminal and the gate of the first transistor as well as the gate/source capacitor of the first transistor.

The first resistor makes it possible, statically, to draw the gate of the first transistor to the ground.

The use of a capacitive divider is particularly advantageous for triggering the switching of the first transistor to the conducting state because this makes it possible to carry out this triggering very quickly when the overvoltage between the two terminals appears.

Moreover, the resistive character of the voltage limiting circuit forms with the first inductive path, a circuit RL that dampens any oscillatory motion and prevents the EMI emissions that were present in the prior art due to the presence of the resonant circuit formed by the decoupling capacitor between the pads PD1 and PD2 and the parasitic inductive element LB1 of FIG. 1.

The resistor of the first transistor in its conducting state advantageously has a value chosen to limit to a limit value the value of the current passing through the first transistor in its conducting state.

Moreover, the coupling capacitor may include for example a single capacitor connected between the first terminal and the gate of the first MOS transistor or a plurality of (for example two) capacitors connected in parallel between the first terminal and the gate of the first MOS transistor.

According to an advantageous embodiment, the voltage limiting circuit further comprises:
a second MOS transistor cascoded with the first MOS transistor and connected to the first terminal,
a second resistor connected between the gate of the second transistor and the first terminal,
a second capacitor connected between the gate of the second transistor and the first terminal.

The second transistor makes it possible to reduce the drain/source voltage of the first transistor in order to minimise, or even eliminate the risk of “snap back” (phenomenon well known to the person skilled in the art characterising particularly by an increase in the substrate current) which could compromise the reliability of the circuit.

The second resistor makes it possible, statically, to draw the gate of the second MOS transistor to the supply voltage.

Finally, when the first transistor starts to lead, the voltage on the drain shared with the first transistor and with the second transistor will reduce and will reduce the gate voltage of the second transistor by the coupling of the gate/drain capacitor of this second transistor. The role of the second capacitor is to counterbalance this effect to keep the gate voltage of the second transistor constant.

According to another aspect, a switched-mode power supply device is proposed, for example but not limitatively of the buck converter type.

This switched-mode power supply device comprises:
an assembly including the voltage limiting circuit as defined above having its first terminal forming a first power supply input of the device and its second terminal forming a second power supply input of the device.

The assembly also includes a pair of MOS transistors, switchable on command, connected between the first terminal and the second terminal of the voltage limiting circuit and having a common node.

The switched-mode power supply device also includes a power supply output as well as an inductive element connected between the common node of the pair of MOS transistors and the power supply output, and an output capacitor connected between the power supply output and the second power supply input.

According to one embodiment, the power supply output is intended to be connected to a load and the resistor of the first transistor of the voltage limiting circuit in its conducting state has a value chosen to limit the value of the current passing through the first transistor in its conducting state to a chosen percentage, for example 50%, of the current intended to pass through the load.

According to another aspect, a processing unit is proposed comprising the assembly of the switched-mode power supply circuit as defined above and a module of this processing unit forming the load and intended to be powered by an output voltage delivered on the power supply output of the switched-mode power supply device.

This processing unit is for example a microcontroller and in this case the module includes a digital core of the microcontroller.

According to another aspect, an integrated circuit is proposed comprising the processing unit as defined above, this integrated circuit moreover having:
a first pad connected to the first power supply input,
a second pad connected to the second power supply input,
a third pad connected to the common node of the pair of transistors of the switched-mode power supply device.

According to yet another aspect, a package is proposed containing the integrated circuit as defined above, this package having:
a first pin connected to the first pad by first bonding means forming the first path at least inductive and capable of receiving the first initial voltage, for example a nominal supply voltage of 3 volts,
a second pin connected to the second pad by second bonding means forming the second path at least inductive and capable of receiving the second initial voltage, for example the ground,
a third pin connected to the third pad by third bonding means at least inductive and capable of being connected to the inductive element.

According to yet another aspect, a support is proposed, for example a printed circuit board, including the package as defined above as well as the inductive element of the switched-mode power supply device as defined above, connected to the third pin of the package, the inductive element of the switched-mode power supply device being moreover connected to the module of the processing unit as defined above, for example the digital core of the microcontroller.

According to yet another aspect, a method is proposed for limiting an overvoltage appearing between a first terminal receiving a first supply voltage from a first initial voltage by means of a first path at least inductive, and a second terminal receiving a second supply voltage from a second initial voltage by means of a second path at least inductive.

This method comprises connecting a first MOS transistor between the two terminals and switching the first MOS transistor to a conducting state when the overvoltage reaches a first threshold value, this switching being automatically triggered by the overvoltage itself, and, the first transistor being conducting, limiting the overvoltage to a second value higher than the first value.

According to yet another aspect, one application of the method as defined above is proposed for limiting an overvoltage appearing between two power supply inputs of a switched-mode power supply device respectively connected to the first terminal and to the second terminal, the two power supply inputs being connected to the two paths at least inductive receiving respectively the two initial voltages.

### BRIEF DESCRIPTION OF THE DRAWINGS

Other advantages and features of the present disclosure will become apparent upon examining the detailed description of non-limiting embodiments and implementations, and from the appended drawings, wherein:

FIG. 1 already described illustrates a prior art;

FIG. 2, FIG. 3, FIG. 4, and FIG. 5 schematically illustrate implementations and embodiments of the present disclosure; and

FIG. 6 illustrates a prior art.

### DETAILED DESCRIPTION

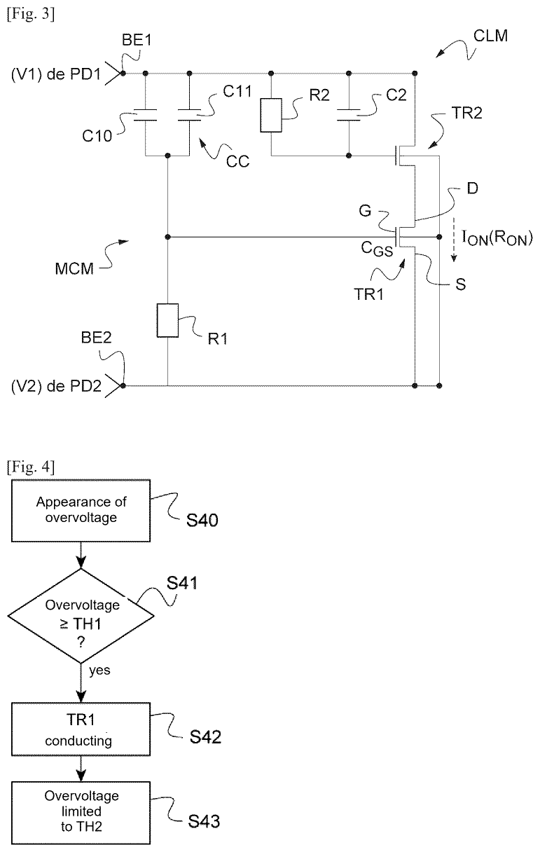

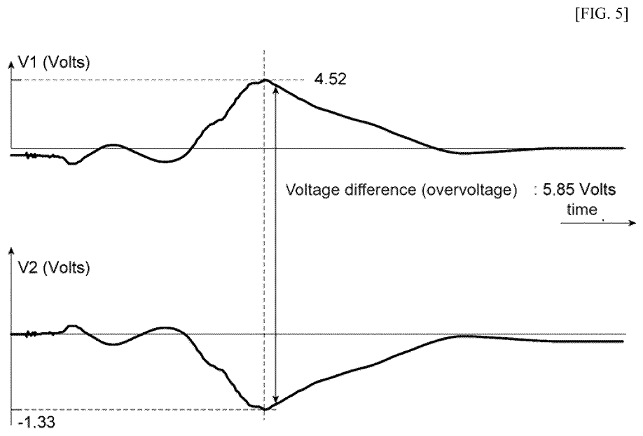

FIG. 2 schematically illustrates one embodiment of the present disclosure.

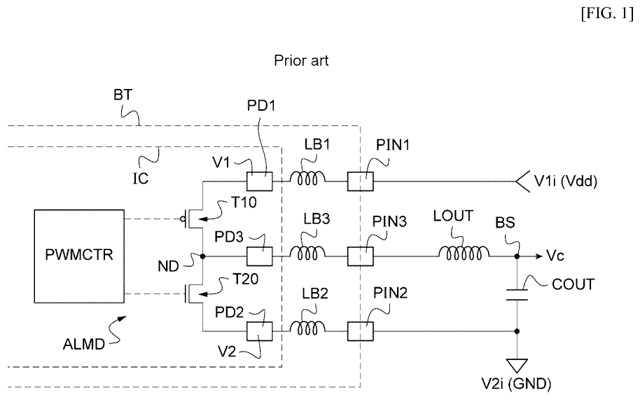

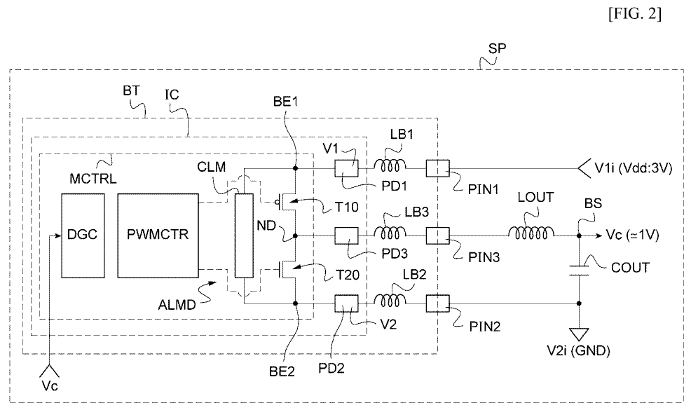

Similar elements or having similar functions to those of FIG. 1 bear the same references as those of these elements of FIG. 1 and will not be described again.

Only the differences between FIG. 2 and FIG. 1 will now be described.

The package BT contains the integrated circuit IC that includes in this embodiment a microcontroller MCTRL having a digital core DGC.

The package BT as well as the inductive element LOUT and the output capacitor COUT of the switched-mode power supply device ALMD are disposed on a support SP, typically a printed circuit board.

The digital core DGC is connected to the power supply output BS of the switched-mode power supply device ALMD in order to be powered by the voltage Vc, typically a voltage of 1 volt.

The integrated circuit IC also includes a voltage limiting circuit CLM having a first terminal BE1 connected to the first pad PD1 and a second terminal BE2 connected to the second pad PD2 so as to receive respectively the first voltage V1 and the second voltage V2.

As explained above, the first voltage V1 is from a first initial voltage V1i, typically a supply voltage VDD having a nominal value of 3 volts whereas the second voltage V2 is from the second initial voltage V2i, typically 0 volt (the ground).

As explained above, during the operation of the switched-mode power supply device, an overvoltage is likely to appear between the two terminals BE1 and BE2.

If reference is now made more particularly to FIG. 3, it can be seen that this voltage limiting circuit CLM includes a first MOS transistor TR1, for example an NMOS transistor of which the source S is connected to the second pad PD2 and of which the gate G is also connected to this second pad PD2 by a first resistor R1.

The voltage limiting circuit CLM includes control means MCM, triggerable by the overvoltage itself and configured to automatically switch the first MOS transistor to a conducting state when the overvoltage reaches a first value and to limit the overvoltage to a second value higher than the first value.

The circuit CLM includes a coupling capacitor CC including in this example two capacitors C10 and C11 connected in parallel between the first terminal BE1 and the gate G of the first transistor TR1.

The coupling capacitor CC forms with the gate/source capacitor CGS of the first transistor TR1 a capacitive divider.

The substrate of the first transistor TR1 is also connected to the second terminal BE2.

The control means MCM include the first resistor R1, the capacitive divider and the resistor RON of the first transistor TR1 in its conducting state.

The circuit CLM also includes a second transistor TR2, here an NMOS transistor, of which the substrate is also connected to the second terminal BE2.

This second transistor TR2 is connected between the first terminal BE1 and the drain of the transistor TR1 according to a cascode assembly.

Its gate is on one side connected to the first terminal BE1 by a second resistor R2 as well as by a second capacitor C2.

Reference is now made more particularly to FIG. 4 to describe the operation of the voltage limiting circuit CLM.

An overvoltage occurs between the terminals BE1 and BE2 of the voltage limiting circuit when the transistor T10 of the switched-mode power supply device switches from the conducting state (ON) to the non-conducting state (OFF).

When an overvoltage appears (step S40 FIG. 4) the first transistor TR1 remains non-conducting until the overvoltage becomes higher than or equal to a first value TH1 (step S41).

This first value TH1 corresponds, given the value of the capacitive divider bridge formed by the coupling capacitor CC and the gate source capacitor of the first transistor TR1, to a gate/source voltage of this transistor TR1 higher than or equal to the threshold voltage of this transistor.

In this case, the first transistor TR1 becomes conducting (step S42). The value of the current ION passing through the transistor TR1 in the conducting state is however low.

In addition, when the overvoltage increases, the transistor becomes increasingly conducting with a current ION increasing until, given a value chosen for the resistor RON of the first transistor, a chosen percentage of the current passing through the load present on the output terminal BS, in this case the digital core DGC of the microcontroller MCTRL, is absorbed.

Given the mutual interaction between the resistor RON and the value of the overvoltage, the latter is then limited to a second value TH2 (step S43).

Of course, the appearance of this overvoltage between the voltage V1 present at the terminal BE1 and the voltage V2 present at the terminal BE2, is only transient and it disappears after a certain amount of time in the order of a few nanoseconds, typically in the order of 2 nanoseconds, after the PMOS transistor T10 has become non-conducting.

The second transistor TR2 makes it possible to reduce the drain/source voltage of the first transistor TR1 to prevent any risk of snap back that could compromise the reliability of the system.

Using a capacitive divider to help switch the first transistor TR1 to its conducting state is particularly advantageous because it makes very fast triggering possible in the order of the nanosecond, when the voltage difference V1−V2 is subjected to an overvoltage.

Moreover, the second capacitor C2 makes it possible to keep the cascode voltage substantially constant when the voltage limitation is activated.

FIG. 5 shows an example of evolution of the voltage V1 and of the voltage V2 respectively at the terminals BE1 and BE2 of the voltage limiting circuit CLM when the transistor T10 switches from the ON state to the OFF state.

This evolution is obtained for components of the circuit CLM having the following features:
capacitor C10: 7.6 pF,
capacitor C11: 7.6 pF,
resistor R1: 11.5 kiloohms,
resistor R2: 11.5 kiloohms,
capacitor C2: 4.75 pF,
first transistor TR1: CGS: 4.75 pF; RON: 5 ohms,
second transistor TR2: CGS: 4.75 pF; RON: 7 ohms.

The transistor TR1 becomes conducting as soon as its gate-source voltage becomes higher than or equal to its threshold voltage which here is equal to 0.6 volts.

Given the capacitive divider that here has a coupling factor in the order of 80%, the transistor TR1 becomes conducting as soon as the overvoltage (voltage difference V1−V2) reaches the first value TH1 equal to 0.75 volts.

At this conduction threshold, the resistor RON of the transistor TR1 is high and will reach the value of 5 ohms at the maximum value of the overvoltage limited to TH2.

More precisely, as can be seen in FIG. 5, the voltage V1 goes up to 4.52 volts whereas the voltage V2 goes down to −1.33 volts leading to an overvoltage limited to TH2=5.85 volts.

The transistor TR1 then absorbs 50% of the current circulating in the digital core of the microcontroller.

The first initial voltage V1i remains constant at 3 volts whereas the second initial voltage V2i remains constant at 0 volt (the ground).

The overvoltage subsequently decreases until the voltage V1 stabilises at 3 volts and the voltage V2 at 0 volt.

This transient overvoltage occurs for a period of 2 nanoseconds.

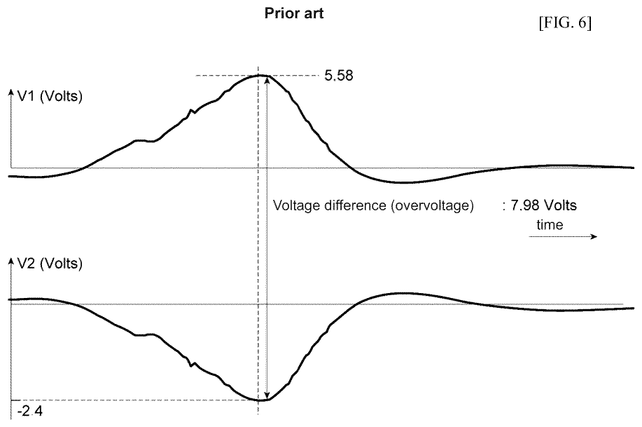

FIG. 6 illustrates the same evolutions of these voltages but with a switched-mode power supply device of the prior art, that is to say without voltage limiting circuit.

It can then be seen that the overvoltage reaches a maximum value in the order of 8 volts which is much higher than the maximum overvoltage obtained with the circuit CLM according to the present disclosure (FIG. 5).

1. A voltage limiting circuit comprising:
a first terminal capable of receiving a first supply voltage from a first initial voltage by means of a first path at least inductive,
a second terminal capable of receiving a second supply voltage from a second initial voltage by means of a second path at least inductive, wherein a voltage difference between the first terminal and the second terminal being an overvoltage,
a first MOS transistor having a drain and a source respectively connected to the first terminal and the second terminal, and
a control means, triggerable by the overvoltage and configured to automatically switch the first MOS transistor to a conducting state when the overvoltage reaches a first value and to limit the overvoltage to a second value higher than the first value.

2. The voltage limiting circuit of claim 1, wherein the control means include:
a first resistor connected between a gate of the first transistor and the second terminal,
a capacitive divider connected between the first transistor and the first terminal, and including a coupling capacitor connected between the first terminal and the gate of the first transistor as well as a gate/source capacitor of the first transistor, and
a resistor of the first transistor in its conducting state.

3. The voltage limiting circuit of claim 2, wherein the resistor of the first transistor in its conducting state has a value chosen to limit to a limit value the value of a current passing through the first transistor in its conducting state.

4. The voltage limiting circuit of claim 1 further comprising:
a second MOS transistor cascoded with the first MOS transistor and connected to the first terminal,
a second resistor connected between the gate of a second transistor and the first terminal, and
a second capacitor connected between the gate of the second transistor and the first terminal.

5. A switched-mode power supply device comprising:
an assembly including the voltage limiting circuit of claim 1 having its first terminal forming a first power supply input of the device and its second terminal forming a second power supply input of the device, and a pair of transistors MOS switchable on command, connected between the first terminal and the second terminal of the voltage limiting circuit and having a common node,
a power supply output, and
an inductive element connected between the common node and the power supply output and an output capacitor connected between the power supply output and the second power supply input.

6. The switched-mode power supply device of claim 5, wherein the switched-mode power supply device is of a buck converter type.

7. The switched-mode power supply device of claim 5, wherein the power supply output is intended to be connected to a load and the resistor of the first transistor of the voltage limiting circuit in its conducting state has a value chosen to limit the value of a current passing through the first transistor in its conducting state at a chosen percentage of a current intended to pass through the load.

8. A processing unit comprising:
the assembly of the switched-mode power supply device of claim 5, and
a module of the processing unit forming a load and capable of being powered by an output voltage delivered on the power supply output of the switched-mode power supply device.

9. The processing unit of claim 8, forming a microcontroller, the module including a digital core of the microcontroller.

10. An integrated circuit including the processing unit of claim 8 and having:
a first pad connected to the first power supply input,
a second pad connected to the second power supply input, and
a third pad connected to the common node.

11. A package containing the integrated circuit of claim 10 and having:
a first pin connected to the first pad by first bonding means forming the first path at least inductive and capable of receiving the first initial voltage,
a second pin connected to the second pad by second bonding means forming the second path at least inductive and capable of receiving the second initial voltage, and
a third pin connected to the third pad by third bonding means at least inductive and capable of being connected to the inductive element.

12. A support, including the package of claim 11 and the inductive element of the switched-mode power supply device, connected to the third pin of the package, the inductive element of the switched-mode power supply device being connected to the module of the processing unit.

13. A method for limiting an overvoltage appearing between a first terminal receiving a first supply voltage from a first initial voltage by means of a first path at least inductive and a second terminal receiving a second supply voltage from a second initial voltage by means of a second path at least inductive, comprising:
connecting a first MOS transistor between the first terminal and the second terminal; and
switching the first transistor to a conducting state when the overvoltage reaches a first value, this switching being automatically triggered by the overvoltage, and, the first transistor being conducting, limiting the overvoltage to a second value higher than the first value.

14. The method of claim 13, further comprising:
limiting an overvoltage between a first power supply input and a second power supply input of a switched-mode power supply device respectively connected to the first terminal and to the second terminal, the first power supply input and the second power supply input connected to the first path at least inductive and the second path at least inductive receiving respectively the first initial voltage and the second initial voltage.
